(19) United States
(12) Patent Application Publication
(10) Pub. No.: US 2016/0239330 A1
(43) Pub. Date: Aug. 18, 2016

(54) Dynamic Reconfiguration Of Resources In A Virtualized Network

(71) Applicants: Alcatel-Lucent USA Inc., Murray Hill, NJ (US); Alcatel Lucent, Boulogne-Billancourt (FR)

(72) Inventors: Alan J Mc Bride, Greystones (IE); Lalita J Jagadeesan, Naperville, IL (US); Marvin C Moser, Kensington, CA (US); Vijay K Gurbani, Lisle, IL (US)

(73) Assignees: Alcatel-Lucent USA Inc., Murray Hill, NJ (US); Alcatel Lucent, Boulogne-Billancourt (FR)

(21) Appl. No.: 14/755,672

(22) Filed: Jun. 30, 2015

Related U.S. Application Data
(60) Provisional application No. 62/115,479, filed on Feb. 12, 2015.

(51) Int. Cl. G06F 9/455; H04L 12/24

(52) U.S. Cl. CPC G06F 9/45558; H04L 41/0813; G06F 2009/45595; G06F 2009/4557

(57) ABSTRACT

A virtualized network including one or more virtual machines is operable to instantiate dynamic reconfiguration of one or more virtual machines. The virtualized network includes an analytics engine, autonomics module and orchestrator module. The autonomics module receives intelligence data from the analytics engine and in one instance, may direct an action of dynamic reconfiguration of one or more virtual machines, based on the intelligence data. The autonomics module instructs the orchestrator module, via a control plane, to instantiate the dynamic reconfiguration of one or more virtual machines. The dynamic reconfiguration may involve, without limitation, replacing a configuration of a virtual machine, migration of a configuration from a first to a second virtual machine, or deploying a second (new) virtual machine to replace or supplement functionality of a first virtual machine.

### FIELD OF THE INVENTION

This invention relates generally to optimization of network resources in a virtualized network.

### BACKGROUND OF THE INVENTION

Network Function Virtualization (NFV) is a concept that provides for abstraction of network resources, for example, implementing telecommunication and/or data network functionality, into logical platforms known as “virtual machines.” For example, network functions traditionally embodied in static network appliances can be abstracted into multiple, software-based virtual machines. Software-Defined Networking (SDN) is a related concept by which control and data planes are decoupled, and management and control of supported network devices is logically centralized into programmable, software-based platforms. Generally, therefore, NFV and SDN define virtualization technologies that enable centralized management and control of today's complex networks, and which promise greater flexibility and scalability than traditional networks. To that end, there is a continuing need to configure virtualized network resources in optimized ways to realize efficiencies of flexibility and scalability associated with certain network functions.

### SUMMARY OF THE INVENTION

This need is addressed and a technical advance is achieved in the art by a method and apparatus for dynamic reconfiguration of resources in a virtualized network. In one example, this reconfiguration involves dynamic instantiation of new policy/rules in a virtual firewall appliance (e.g., SIP firewall), which may be in a pre-existing SIP firewall or in a new or different SIP firewall. In another example, it involves migration of policy/rules from a first virtualized SIP firewall to a second virtualized SIP firewall. More generally, the reconfiguration may be expressed in one example as dynamic instantiation of a new configuration in a virtual network function (VNF) appliance, such as a virtual machine (VM), which may be in a pre-existing or in a new or different VM. In another example, it involves migration of a configuration from a first to a second VM. The VNF appliance(s) may exhibit generally any virtualized network functionality (i.e., not limited to firewall or security functionality).

### BRIEF DESCRIPTION OF THE DRAWINGS

The foregoing and other advantages of the invention will become apparent upon reading the following detailed description and upon reference to the drawings in which:

FIG. 1 is a block diagram of a virtualized network including a SIP firewall according to an embodiment of the present invention;

FIG. 2 depicts a first example reconfiguration of a virtualized SIP firewall;

FIG. 3 depicts a second example reconfiguration of a virtualized SIP firewall;

FIG. 4 depicts a third example reconfiguration of a virtualized SIP firewall;

FIG. 5 depicts a first generalized example reconfiguration of a virtual network function (VNF);

FIG. 6 depicts a second generalized example reconfiguration of a VNF; and

FIG. 7 depicts a third generalized example reconfiguration of a VNF.

### DESCRIPTION OF THE PREFERRED EMBODIMENT(S)

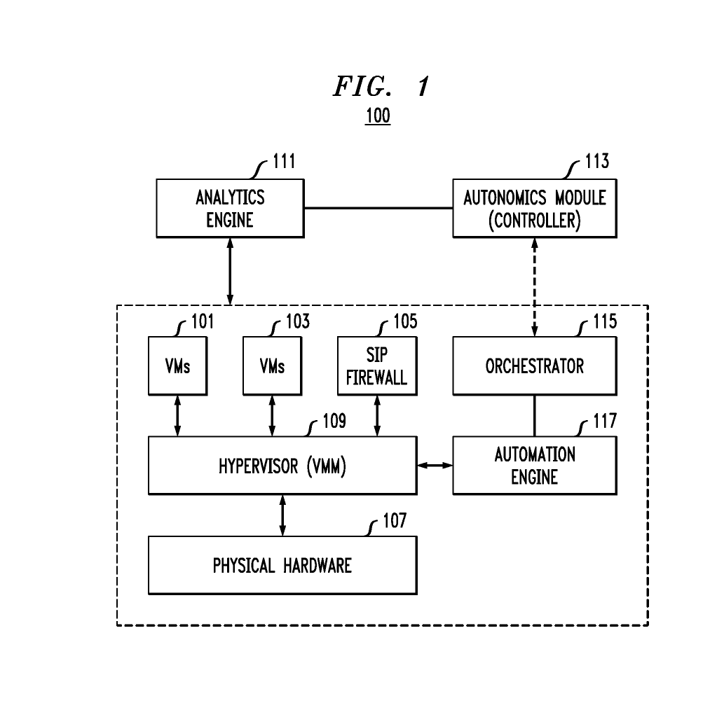

FIG. 1 illustrates the logical configuration of a virtualized network 100 according to an embodiment of the present invention. The virtualized network 100 includes one or more virtual machines (VMs) 101, 103, 105 in program execution over physical hardware 107 via a virtual machine monitor (VMM) 109 (also known as a “hypervisor”). Generally, the VMs 101, 103, 105 provide virtualized functionality of the network 100 under control of the VMM 109.

In one example, the network 100 comprises an IP network based on the Session Initiation Protocol (SIP) call control protocol. For example, the network 100 may define the core portion of an IP Multimedia Subsystem (IMS) network, which is a SIP-based converged network (i.e., having mobile users as well as fixed-access users). Thus, in one example, the VMs 101, 103, 105 provide virtualized functionality that supports IMS services, such as may include without limitation, SIP-based voice-over-IP services. In such case, IMS users (not shown) communicate with one or more of the VMs to accomplish, without limitation, SIP registrations, SIP session requests, and user authentications to initiate voice-over-IP calls.

In one embodiment, VM 105 defines a virtualized SIP firewall, loosely defined as a computational resource that blocks attacks mounted through SIP messages. For example and without limitation, the VM 105 operating as a virtualized SIP firewall must deal with Distributed Denial of Service (DDoS) attacks, which attempt to overload the network with large numbers of illegitimate (“spoofed”) SIP calls so as to deny service to legitimate users. Accordingly, in one embodiment, the VM 105 may block certain senders or IP addresses that are suspected sources of DDoS attacks.

The VM 105 is deployed in a first instance as a pre-existing and pre-y) configured virtualized SIP firewall for the network 100. That is, it is a computational resource that addresses known threats (i.e., with known threat signatures), according to execution of pre-existing and pre-configured policies and/or rules. According to embodiments described herein, the flexibility of virtualization is used to dynamically instantiate a second instance of a virtualized SIP firewall when new or unknown threats are detected or suspected. For example, as will be described in greater detail hereinafter, the VM 105 may be dynamically adapted to execute newly defined or newly adapted policy/rules, thereby defining a second instance of virtualized SIP firewall, replacing or supplementing the functionality of the previously configured virtualized SIP firewall to address the newly identified threats. In another example, a second instance of virtualized SIP firewall may be realized in a different pre-existing resource or in a newly-created resource to execute new functionality (e.g., newly defined policy/rules) or to migrate certain functionality of the previously configured SIP firewall to address newly identified threats in potentially vulnerable parts of the network.

As shown, the virtualized network 100 includes an analytics engine 111 to monitor the network 100, and an autonomics module 113 operable to receive intelligence data from the analytics engine 111. The autonomics module 113 is operable to identify actions to be taken responsive to the intelligence information and to formulate instructions to an orchestration module 115 (hereinafter, “orchestrator”) to carry out the actions. The orchestrator 115 provides instructions via network virtualization and automation engine 117 to the VMM 109 to control the VMs 101, 103, 105 to carry out the instructions and to perform virtualized functions of the network 100.

The analytics engine 111 is operable to monitor and collect intelligence associated with the network 100 via methods of data analytics. In one embodiment, the analytics engine 111 detects attacks to the network 100 through use of anomaly detection algorithms (in one example, machine-learning-based anomaly detection algorithms) on real-time or stream-based data. The algorithms can be built on commercial or open-source technologies. Machine-learning algorithms can provide real-time information as to anomalies taking place in the network, and can detect new, unknown, or previously known threats. For example, in the instance of the network 100 defining a SIP-based network, such as an IMS network, the analytics engine 111 may execute machine-learning algorithm to detect DDoS attacks or suspected DDoS attacks from characteristics of SIP-based message traffic generated externally from user devices communicating via the network or attempting to gain access to the network, or from characteristics of SIP message traffic generated within the network 100. As will be appreciated, an attack can be detected using any number of suitable methods, either known or yet to be devised.

In one embodiment, responsive to detecting an attack or suspected attack, the analytics engine 111 communicates data representing intelligence information to the autonomics module 113. For example and without limitation, the analytics engine may detect and identify malicious IP addresses that are suspected sources of DDoS attacks and communicate to the autonomics module a continually-updated list of the malicious IP addresses that are (knowingly or unknowingly) participating in the attack. The analytics engine might further report the nature and/or severity of the attacks, the network resources or portions of the network that have been compromised or that are most vulnerable to the attacks, or the like.

The autonomics module 113 receives intelligence information from the analytics engine 111 and identifies actions, if any, that should be taken responsive to the received intelligence. In one embodiment, the autonomics module 113 identifies actions according to a configurable policy that maps certain intelligence to certain actions. For example, the autonomics module may be pre-configured with a policy to block malicious IP addresses identified by the analytics engine as suspected sources of DDoS attacks. Accordingly, in the instance that the autonomics module 113 receives information about malicious IP addresses from the analytics engine, the autonomics module may make a determination governed by the pre-configured policy to block the identified IP addresses for a period of time. Alternatively or additionally, the policy may dictate instantiation of new virtual resources or migration of certain network resources or functionality to other parts of the network.

Consistent with principles of Software-Defined Networking (SDN), the autonomics module 113 is generally defined as a controller, operating in a control plane, that makes decisions and formulates instructions based on a configurable policy, but which is decoupled from the data plane and does not itself control execution of the virtualized resources of the underlying network infrastructure. Rather, the autonomics module 113 communicates instructions to the orchestrator 115, which operates in the data plane, to control execution of underlying hardware resources that are necessary to realize virtualized network functions. Therefore, the orchestrator 115 is generally defined as a controller, operating in the data plane, to control execution of network hardware to realize virtualized network functions. Accordingly, responsive to receiving instructions from the autonomics module 113, the orchestrator 115 promulgates data representing information or instructions to automation engine 117, VMM 109 and to the relevant VMs 101, 103, 105 to coordinate execution of instruction(s) to control or change some aspect of the virtualized network 100.

As will be appreciated, the elements of FIG. 1 are logical components that may be implemented in one or more physical devices comprising, without limitation, firmware, microchips (e.g., ASICs), software executable on a hardware device, hardware, specialized hardware, and/or the like. Certain elements may reside in a single dedicated physical device, may reside collectively with other components or portions of components in the same physical device or may be distributed among multiple physical devices. The components may include one or more processors including, without limitation, dedicated or shared processors operable to execute program code, defining machine- or computer-readable and executable instructions stored in a digital storage media, wherein execution of the program code cause the components to execute actions described herein. The digital storage media may comprise, without limitation, digital memories, magnetic storage media, hard drives, or optically readable digital data storage media. The elements may implement one or more communication technologies including wired, wireless or packet-based links.

FIGS. 2-4 illustrate the flexibility of virtualization according to certain embodiments of the invention. In each of FIGS. 2-4, a first instance 202 of SIP firewall is deployed in VM 105 as a pre-existing and pre-configured virtualized SIP firewall operating in context of a virtualized network 100 having elements substantially as described in relation to FIG. 1. In the first instance 202, the VM 105 executes a first set 204 of policies and/or rules (for convenience, denoted “policy 1”). Sometime after, a second instance 206 of SIP firewall is dynamically instantiated, for example responsive to the analytics engine 111 detecting an attack or suspected attack and communicating intelligence information to the autonomics module 113, the autonomics module 113 determining that the second instance of SIP firewall should be instantiated and communicating an instruction to the orchestrator 115 to instantiate the second instance of SIP firewall. Thereafter, the orchestrator 115 instructs the automation engine 117, VMM 109 and to the relevant VMs to dynamically initiate the second instance 206 of SIP firewall.

In the example of FIG. 2, a second instance 206 of SIP firewall is deployed in VM 105 as a newly defined or adapted second set 208 of policies and/or rules (“policy 2”) operated to replace policy 1, thereby transforming VM 105 to operate with different functionality, at least in part, relative to its predefined configuration to address newly identified threats.

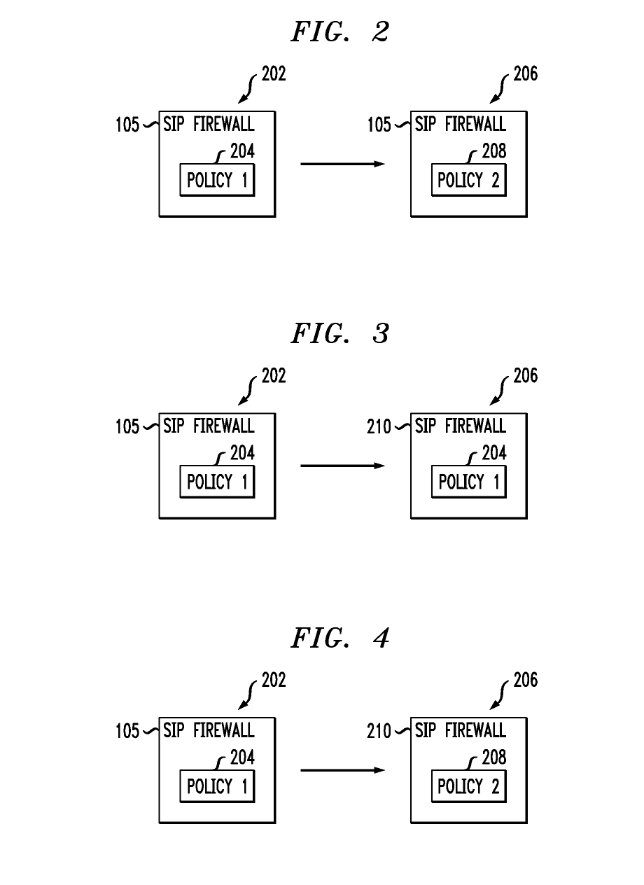

In the example of FIG. 3, a second instance 206 of SIP firewall is deployed in a different or newly-created virtual resource (e.g., VM 210) to execute the same set 204 of policies and/or rules (“policy 1”) that was implemented in VM 105. Optionally, the new or different virtual resource VM 210 may be operated to replace or supplement the pre-existing resource VM 105, so as to migrate the functionality of VM 105 into a different resource or to duplicate the functionality of VM 105 into a different part of the network to address newly identified threats.

In the example of FIG. 4, a second instance 206 of SIP firewall is deployed in a different or newly-created virtual resource (e.g., VM 210) to execute a newly defined or adapted second set 208 of policies and/or rules (“policy 2”). The new or different virtual resource VM 210 (executing policy 2) may be operated to replace or supplement the pre-existing resource VM 105 (executing policy 1), so as to impart new functionality into a different part of the network to address newly identified threats.

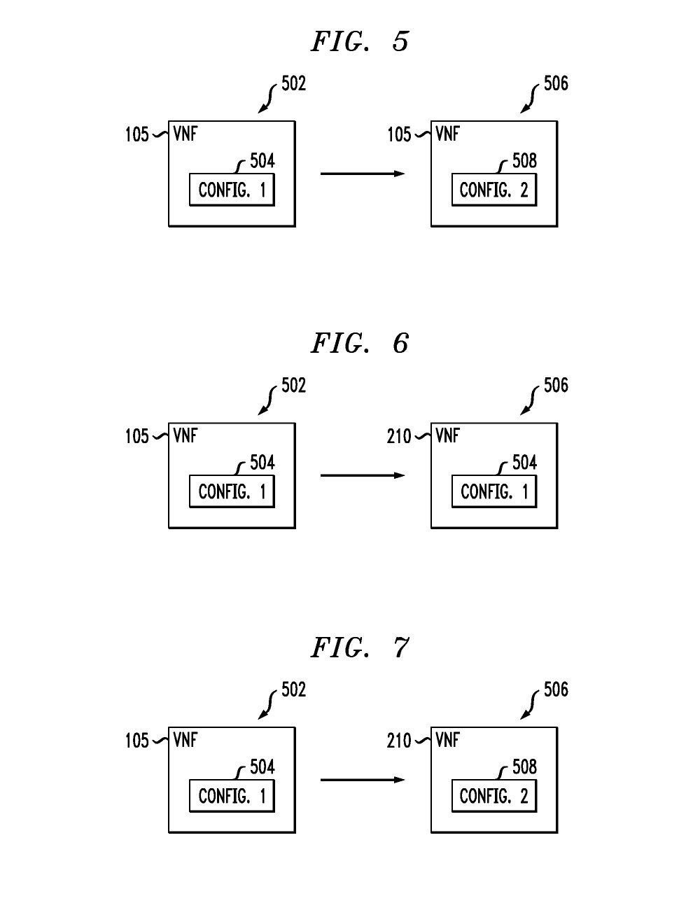

As will be appreciated, principles of the invention are not limited to examples of virtual firewall appliance (e.g., SIP firewall) or other security appliances. It is contemplated that embodiments of the invention may be realized to dynamically instantiate new or different functionality in pre-existing resources other than security appliances, or to migrate or supplement certain functionality other than security functionality into new or different resources in different parts of the network. The generalized embodiments are shown in FIGS. 5-7.

In each of FIGS. 5-7, a virtual network function (“VNF”) is deployed in a virtualized appliance (as shown, VM 105), defining a VNF appliance operating in context of a virtualized network 100 having elements substantially as described in relation to FIG. 1. The VNF may exhibit generally any virtualized network functionality (i.e., not limited to firewall or security functionality). In a first instance 502, the VNF operates according to a first configuration of instructions, policies and/or rules (for convenience, denoted “config 1”). Sometime thereafter, responsive to the analytics engine 111 communicating intelligence information to the autonomics module 113, the autonomics module 113 determines that a second instance 506 of VNF should be instantiated. Accordingly, the autonomics module instructs the orchestrator 115 to instantiate the second instance of VNF. Thereafter, the orchestrator 115 instructs the automation engine 117, VMM 109 and to the relevant VMs to dynamically initiate the second instance 506 of VNF.

In the example of FIG. 5, a second instance 506 of VNF is deployed in VM 105 as a newly defined or adapted second configuration of instructions, policies and/or rules (denoted “config 2”) operated to replace config 1, thereby transforming VM 105 to operate with different functionality, at least in part, relative to its predefined configuration to dynamically address certain needs of the virtualized network.

In the example of FIG. 6, a second instance 506 of VNF is deployed in a different or newly-created virtual resource (e.g., VM 210) to execute the same configuration of instructions, policies and/or rules (“config 1”) that was implemented in VM 105. Optionally, the new or different virtual resource VM 210 may be operated to replace or supplement the pre-existing resource VM 105, so as to migrate the functionality of VM 105 into a different resource or to duplicate the functionality of VM 105 into a different part of the network to address certain needs of the virtualized network.

In the example of FIG. 7, a second instance 506 of VNF is deployed in a different or newly-created virtual resource (e.g., VM 210) to execute a newly defined or adapted second configuration of instructions, policies and/or rules (“config 2”). The new or different virtual resource VM 210 (executing config 2) may be operated to replace or supplement the pre-existing resource VM 105 (executing config 1), so as to impart new functionality into a different part of the network to address certain needs of the virtualized network.

The term “dynamic reconfiguration,” and the terms “instantiation,” “instantiating” and other derivative terms as used herein in the context of dynamic instantiation of a virtual network function (VNF), which in one example comprises a SIP firewall, is generally defined as a change in configuration or implementation of a VNF that occurs substantially “automatically” (i.e., without human intervention) based on automated execution of instructions initiated from the orchestrator 115 responsive to instruction(s) from the autonomics module 113 and intelligence from the analytics engine 111. It is contemplated, without limitation, that dynamic instantiation of a VNF can occur substantially quickly (e.g., on the order of seconds). Suffice it to say that dynamic reconfiguration can occur much more rapidly than reconfiguration that involves human intervention to reprogram or upload new software programs, replace or add physical components, or the like.

FIGS. 1-7 and the foregoing description depict specific exemplary embodiments of the invention to teach those skilled in the art how to make and use the invention. The described embodiments are to be considered in all respects only as illustrative and not restrictive. The present invention may be embodied in other specific forms without departing from the scope of the invention which is indicated by the appended claims. All changes that come within the meaning and range of equivalency of the claims are to be embraced within their scope.

What is claimed is:

1. In a virtualized network including one or more virtual machines operable to perform a virtual network function (VNF), a method comprising:
receiving intelligence data associated with the network;
identifying certain actions based on the intelligence data, according to a preconfigured policy, wherein the actions include in at least one instance, an action of dynamic reconfiguration of one or more virtual machines;
instructing one or more devices via a control plane to instantiate the action of dynamic reconfiguration of one or more virtual machines;
wherein the virtualized network includes at least a first virtual machine operable according to a first configuration, the action of dynamic reconfiguration comprising one or more of:
reconfiguration of the first virtual machine to become operable according to a second configuration, thereby replacing a configuration of the first virtual machine;
deploying at least a second virtual machine to become operable according to the first configuration, thereby migrating a configuration from a first virtual machine to a second virtual machine; and
deploying at least a second virtual machine to become operable according to a second configuration, replacing or supplementing functionality of the first virtual machine.

2. The method of claim 1, performed by an autonomics module of the virtualized network.

3. The method of claim 2, wherein the step of receiving comprises the autonomics module:
receiving the intelligence data from an analytics engine having executed one or more anomaly detection algorithms to collect the intelligence data.

4. The method of claim 2, wherein the step of receiving comprises the autonomics module:
receiving the intelligence data from an analytics engine having executed one or more machine-learning-based anomaly detection algorithms to collect the intelligence data.

5. The method of claim 2, wherein the step of instructing comprises the autonomics module:
instructing an orchestration module to instantiate the action of dynamic reconfiguration of one or more virtual machines.

6. The method of claim 1, wherein the action of dynamic reconfiguration comprises reconfiguration of the first virtual machine to become operable according to a second configuration, thereby replacing a configuration of the first virtual machine.

7. The method of claim 6, wherein the first virtual machine defines a virtualized firewall operable according to a first firewall policy, the action of dynamic reconfiguration comprising reconfiguration of the first virtual machine to become operable according to a second firewall policy, thereby replacing a configuration of the first virtual machine.

8. The method of claim 1, wherein the action of dynamic reconfiguration comprises deploying at least a second virtual machine to become operable according to the first configuration, thereby migrating a configuration from a first virtual machine to a second virtual machine.

9. The method of claim 8, wherein the first virtual machine defines a virtualized firewall operable according to a first firewall policy, the action of dynamic reconfiguration comprising deploying at least a second virtual machine defining a virtualized firewall to become operable according to the first firewall policy, thereby migrating a configuration from a first virtual machine to a second virtual machine.

10. The method of claim 1, wherein the action of dynamic reconfiguration comprises deploying at least a second virtual machine to become operable according to a second configuration, replacing or supplementing functionality of the first virtual machine.

11. The method of claim 10, wherein the first virtual machine defines a virtualized firewall operable according to a first firewall policy, the action of dynamic reconfiguration comprising deploying at least a second virtual machine defining a virtualized firewall to become operable according to a second firewall policy, replacing or supplementing functionality of the first virtual machine.

12. In a virtualized network including one or more virtualized network resources operable to perform a virtual network function (VNF), A system comprising:
an analytics engine operable to monitor and collect intelligence data associated with the virtualized network;
an autonomics module operable to receive the intelligence data from the analytics engine and to identify certain actions according to a preconfigured policy, based on the intelligence data, the autonomics module operable in a control plane to instruct one or more devices to instantiate the actions, wherein the actions include in at least one instance, an action of dynamic reconfiguration of one or more virtualized network resources;
wherein the virtualized network includes at least a first virtualized network resource operable according to a first configuration, the action of dynamic reconfiguration comprising one or more of:
reconfiguration of the first virtualized network resource to become operable according to a second configuration, thereby replacing a configuration of the first virtualized network resource;
deploying at least a second virtualized network resource to become operable according to the first configuration, thereby migrating a configuration from a first virtualized network resource to a second virtualized network resource; and
deploying at least a second virtualized network resource to become operable according to a second configuration, replacing or supplementing functionality of the first virtualized network resource.

13. The system of claim 12, further comprising:
an orchestration module operable to receive instructions from the autonomics module, the orchestration module operable in a data plane to instantiate the action of dynamic reconfiguration of the virtualized network resource.

14. An apparatus comprising:
a controller comprising an autonomics module operable to:
receive network intelligence data from an analytics engine;
identify certain actions based on the intelligence data, according to a preconfigured policy, wherein the actions include in at least one instance, an action of dynamic reconfiguration of one or more virtual machines; and
instruct an orchestration module via a control plane to instantiate the action of dynamic reconfiguration of one or more virtual machines.

15. The apparatus of claim 14, wherein the autonomics module is operable, in the instance of identifying an action of dynamic reconfiguration of one or more virtual machines, to formulate an instruction to replace a configuration of at least a first virtual machine.

16. The apparatus of claim 14, wherein the autonomics module is operable, in the instance of identifying an action of dynamic reconfiguration of one or more virtual machines, to formulate an instruction to migrate a configuration from a first virtual machine to a second virtual machine.

17. The apparatus of claim 14, wherein the autonomics module is operable, in the instance of identifying an action of dynamic reconfiguration of one or more virtual machines, to formulate an instruction to deploy a second virtual machine to replace or supplement functionality of a first virtual machine.
